(19) United States
(12) Patent Application Publication
(10) Pub. No.: US 2026/0178342 A1
(43) Pub. Date: Jun. 25, 2026

(54) IMAGE PROCESSING APPARATUS, DRIVER INSTALLATION METHOD AND COMPUTER-READABLE RECORDING MEDIUM ENCODED WITH DRIVER INSTALLATION PROGRAM

(71) Applicant: Konica Minolta, Inc., Tokyo (JP)

(72) Inventor: Tomonori Satou, Tokyo (JP)

(73) Assignee: Konica Minolta, Inc., Tokyo (JP)

(21) Appl. No.: 19/425,981

(22) Filed: Dec. 18, 2025

(30) Foreign Application Priority Data
Dec. 20, 2024 (JP) 2024-225640

(51) Int. Cl. G06F 9/4401; G06F 8/61

(52) U.S. Cl. CPC G06F 9/4415; G06F 8/61

(57) ABSTRACT

An image processing apparatus includes a hardware processor equipped with an interface to which a card reading device is connected, wherein the hardware processor acquires device information representing a type of the card reading device connected to the interface, installs any one test program out of a plurality of driver programs corresponding to the device information, controls a driver that executes the test program to acquire card information representing a type of a card to be read by the card reading device, and determines, based on the card information, an adapted program that is adapted to the card from among the plurality of driver programs.

### Cross-Reference to Related Applications

The entire disclosure of Japanese patent Application No. 2024-225640 filed on December 20, 2024, is incorporated herein by reference in its entirety.

### Background of the invention

### Technical Field

The present invention relates to an image processing apparatus, a driver installation method, and a computer-readable recording medium encoded with a driver installation program. The present invention relates to an image processing apparatus to which a card reading device is connected, a driver installation method executed by the image processing apparatus, and a computer-readable recording medium encoded with a driver installation program that causes a computer to execute the driver installation method.

### Description of Related Art

A card reading device may be connected to an image processing device represented by a Multi Function Peripheral (MFP). The card reading device reads information stored in a card such as an IC card or a magnetic card. In order for the MFP to control the card reading device connected to the MFP, a driver program needs to be installed in the MFP. Japanese Unexamined Patent Application Publication No. JPH 08-328831 describes an information processing apparatus that includes a means for identifying a type of a mounted IC card, a means for notifying a database storing application software for an IC card of the type, a means for receiving a list of the application software for the mounted IC card from the database, a means for selecting desired application software from the list, a means for downloading the selected application software from the database, and a means for installing the downloaded application software. The information processing apparatus includes a PCMCIA card controller, which identifies the type of an IC card mounted on the PCMCIA card controller.

In recent years, many card reading devices have Universal Serial Buses (USB) as connection interfaces for connection with external devices. In a case in which the MFP 100 includes a USB host controller, a card reading device can be connected to the USB host controller through a USB cable. On the other hand, since USB is a general standard, the vendors and the models of the card reading devices to be connected to a USB port of the MFP are not necessarily the same. Further, an electronic device of a type different from a card reading device may be connected. Therefore, unlike the PCMCIA card controller of Japanese Unexamined Patent Application Publication No. JPH 08-328831, the MFP cannot control a card reading device connected to the USB host controller through the USB cable with a driver that controls the card reading device not being installed. Therefore, the MFP cannot acquire the type of a card from the card reading device.

### Summary of the invention

According to one aspect of the present invention, an image processing apparatus includes a hardware processor equipped with an interface to which a card reading device is connected, wherein the hardware processor acquires device information representing a type of the card reading device connected to the interface, installs any one test program out of a plurality of driver programs corresponding to the device information, controls a driver that executes the test program to acquire card information representing a type of a card to be read by the card reading device, and determines, based on the card information, an adapted program that is adapted to the card from among the plurality of driver programs.

According to another aspect of the present invention, a driver installation method is executed by an image processing apparatus, with the image processing apparatus being equipped with an interface to which a card reading device is connected, and includes acquiring device information representing a type of the card reading device connected to the interface, installing any one test program out of a plurality of driver programs corresponding to the device information, controlling a driver that executes the test program and acquiring card information representing a type of a card to be read by the card reading device, and determining, based on the card information, an adapted program that is adapted to the card from among the plurality of driver programs.

According to another aspect of the present invention, a computer-readable recording medium is encoded with a driver installation program, with the driver installation program being executed by a computer that controls an image processing apparatus equipped with an interface to which a card reading device is connected, wherein the driver installation program causes the computer to acquire device information representing a type of the card reading device connected to the interface, install any one test program out of a plurality of driver programs corresponding to the device information, control a driver that executes the test program and acquire card information representing a type of a card to be read by the card reading device, and determine, based on the card information, an adapted program that is adapted to the card from among the plurality of driver programs.

### Brief Description of the Drawings

The advantages and features provided by one or more embodiments of the invention will become more fully understood from the detailed description given hereinbelow and the appended drawings which are given by way of illustration only, and thus are not intended as a definition of the limits of the present invention.

FIG. 1 is a diagram illustrating the overview of an image processing system in one embodiment of the present invention;

FIG. 2 is a perspective view illustrating the appearance of an MFP;

FIG. 3 is a block diagram illustrating the overview of the hardware configuration of the MFP in the present embodiment;

FIG. 4 is a block diagram illustrating one example of the functions of the MFP in the present embodiment;

FIG. 5 is a diagram illustrating one example of a device table;

FIG. 6 is a diagram illustrating one example of driver association information;

FIG. 7 is a diagram illustrating one example of a reading operation request screen;

FIG. 8 is a flowchart illustrating one example of a flow of a driver installation process;

FIG. 9 is a diagram illustrating one example of an installation confirmation screen; and

FIG. 10 is a diagram illustrating one example of a setting completion screen.

### Detail Description

Hereinafter, one or more embodiments of the present invention will be described with reference to the drawings. However, the scope of the invention is not limited to the disclosed embodiments.

Embodiments of the present invention will be described below with reference to the drawings.

In the following description, the same components are denoted by the same reference numerals. Their names and functions are also the same. Therefore, a detailed description thereof will not be repeated.

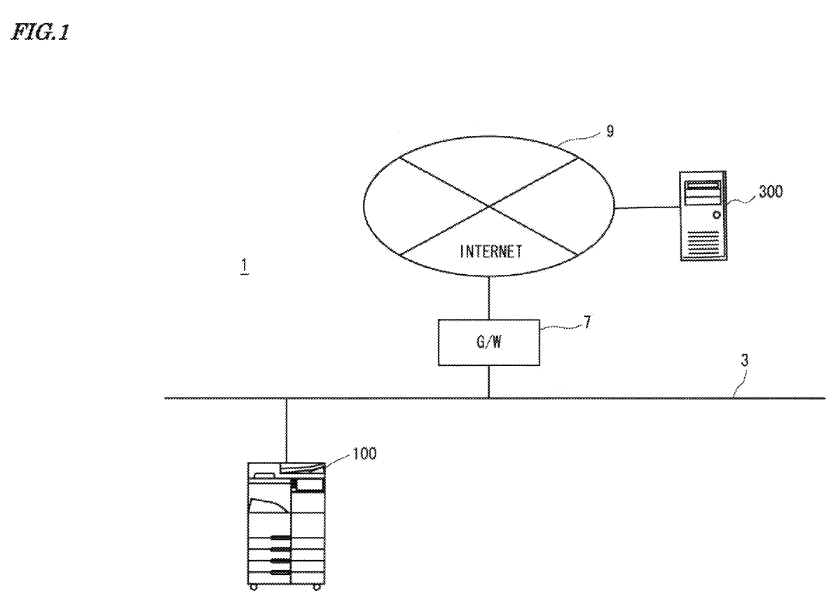

FIG. 1 is a diagram illustrating the overview of an image processing system in one embodiment of the present invention. With reference to FIG. 1, the image processing system 1 includes a Multi Function Peripheral (MFP) 100 and a server 300.

The MFP 100 is connected to a network 3. The network 3 is a Local Area Network (LAN), either wired or wireless. Further, the network 3 is not limited to the LAN and may be a network using Public Switched Telephone Networks. Further, the network 3 may be a Wide Area Network (WAN) such as the Internet. The MFP 100 can communicate with another computer connected to the network 3 through the network 3.

A gateway (G/W) device 7 is connected to the network 3 and is connected to the Internet 9. The G/W 7 relays the communication between the network 3 and the Internet 9. The server 300 is connected to the Internet 9. The MFP 100 is connected to the Internet 9 through the network 3 and the G/W 7. Therefore, the MFP 100 can communicate with the server 300 through the network 3 and the Internet 9.

The MFP 100 is one example of an image processing apparatus. The server 300 is a general computer. Because the hardware configuration and functions are well known, a description thereof will not be repeated. In the present embodiment, the server 300 is provided by a manufacturer that manufactures the MFP 100 or a vendor. The server 300 has a function of maintaining or managing the MFP 100. Here, the server 300 stores a program that can be installed in the MFP 100. The server 300 downloads a requested program onto the MFP 100 in response to a request made by the MFP 100. The MFP 100 installs the program downloaded from the server 300, thereby executing the program.

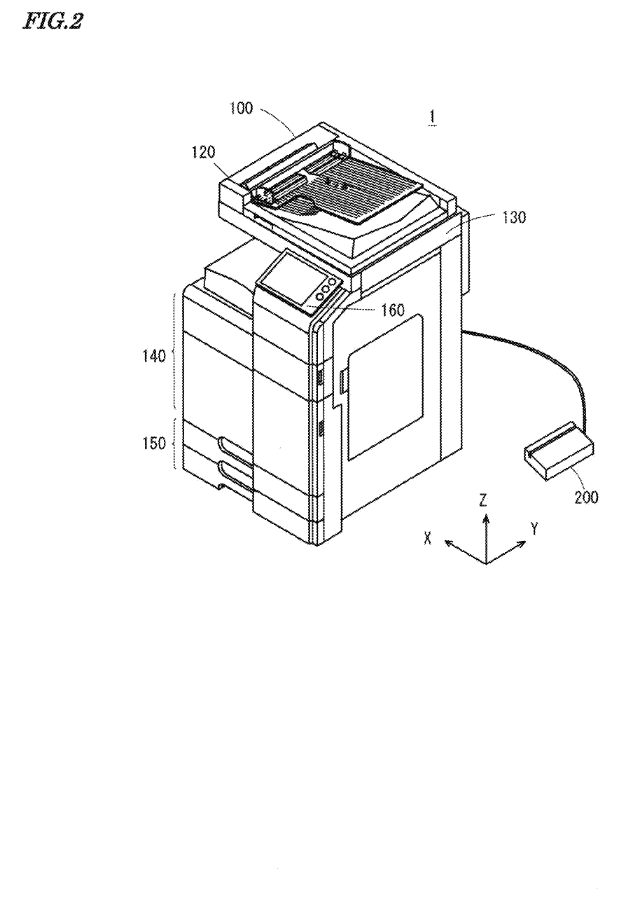

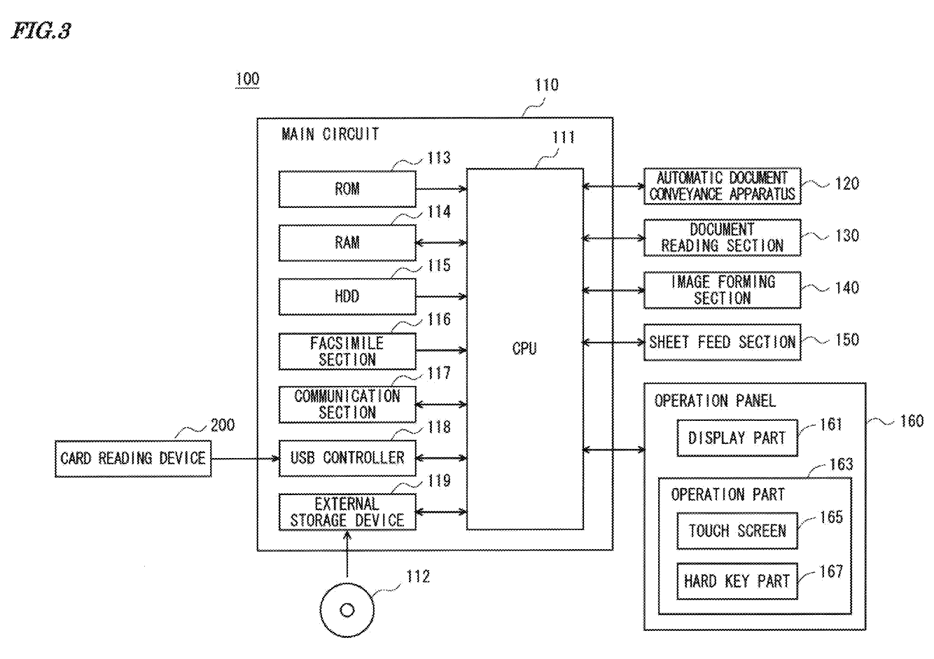

FIG. 2 is a perspective view illustrating the appearance of an MFP. FIG. 3 is a block diagram illustrating the overview of the hardware configuration of the MFP in the present embodiment. With reference to FIGS. 2 and 3, the MFP 100 includes a main circuit 110, an automatic document conveyance apparatus 120, a document reading section 130, an image forming section 140, a sheet feed section 150 and an operation panel 160.

The automatic document conveyance apparatus 120 automatically conveys a plurality of documents set on a document tray to a document reading position of the document reading section 130 one by one. The automatic document conveyance apparatus 120 discharges a document having an image formed thereon by the document reading section 130 onto a document ejection tray.

The document reading section 130 reads an image of a document set at the document reading position by optically scanning the document. The document reading section 130 includes a photoelectric conversion element such as a Charge Coupled Devices (CCD), and converts light obtained by scanning the document into an electrical signal. The document reading section 130 converts an electrical signal obtained by reading the document into image data, which is a digital signal, and outputs the image data.

The image forming section 140 includes respective image forming units for respective yellow, magenta, cyan and black. At least one of the four image forming units is driven, so that an image is formed on a recording medium such as a sheet. When all four of the image forming units are driven, a full-color image is formed on a recording medium.

The sheet feed section 150 includes one or more sheet feed cassettes, takes out a sheet from any one of the one or more sheet feed cassettes, and supplies the sheet to the image forming section 140.

The MFP 100 includes a USB port. Here, a card reading device 200 is connected to the USB port included in the MFP 100, by way of example.

The card reading device 200 is a general card reader. The card reading device 200 is supplied by a plurality of vendors. Therefore, the card reading device 200 connected to the MFP 100 is supplied by any of the plurality of vendors. Further, one vendor may supply a plurality of types of card reading devices. The card reading device 200 connected to the MFP 100 is one of the plurality of types of card reading devices supplied by a certain vendor.

The main circuit 110 includes a CPU 111, a ROM 113, a RAM 114, an HDD 115, a facsimile section 116, a communication section 117, a USB controller 118 and an external storage device 119. The CPU 111 is connected to the ROM 113, the RAM 114, the HDD 115, the facsimile section 116, the communication section 117, the USB controller 118 and the external storage device 119 through a bus. The CPU 111 is connected to the automatic document conveyance apparatus 120, the document reading section 130, the image forming section 140, the sheet feed section 150 and the operation panel 160, and controls the MFP 100 as a whole.

The ROM 113 stores a program to be executed by the CPU 111 or data required for execution of the program. The RAM 114 is used as a work area when the CPU 111 executes a program. Further, the RAM 114 temporarily stores image data successively sent from the document reading section 130. The HDD 115 is a mass storage device. Instead of the HDD 115, a Solid State Drive (SSD) may be used.

The facsimile section 116 is connected to a Public Switched Telephone Network (PSTN) and transmits facsimile data to the PSTN, and the facsimile section 116 receives facsimile data from the PSTN. The facsimile section 116 stores the received facsimile data in the HDD 115. Further, the facsimile section 116 converts the facsimile data into print data that is printable in the image forming section 140 and outputs the print data to the image forming section 140. Thus, the image forming section 140 forms, on a sheet, an image represented by the facsimile data received from the facsimile section 116. Further, the facsimile section 116 converts the data stored in the HDD 115 into facsimile data and transmits the converted facsimile data to a facsimile machine connected to the PSTN.

The communication section 117 is a communication interface for connecting the CPU 111 to the network 3. The communication section 117 communicates using a communication protocol such as a Transmission Control Protocol (TCP) or a File Transfer Protocol (FTP). The communication section 117 has a network port to which a network cable is connected.

The USB controller 118 has a USB port to which a USB cable is connected. A USB device is connected to the USB controller 118. The USB controller 118 manages and controls the USB device connected to the USB port. The USB controller 118 has a polling function and a data transfer function of the USB device. The polling function of the USB device is a function of periodically polling the USB device connected to the USB port and transmitting and receiving data. The USB device has a built-in USB device controller. The USB device controller executes a process of transmitting and receiving data in the USB device and a process of detecting an event on a USB bus. In the process of transmitting and receiving data, a process of providing device information is executed. When being connected to the USB controller 118, the USB device controller transmits a vendor ID and a product ID to the USB controller 118. The vendor ID is the information for identifying the vendor of the USB device. The product ID is the information for identifying the type of the USB device.

In the present embodiment, the card reading device 200 is connected as a USB device, by way of example. In a case in which the card reading device 200 is connected to the USB port, the USB controller 118 acquires the vendor ID and the product ID of the card reading device 200 and outputs them to the CPU 111. Further, the USB controller 118 receives an instruction from the CPU 111, transmits data to the card reading device 200, and outputs the data received from the card reading device 200 to the CPU 111.

The operation panel 160 is provided on an upper surface of the MFP 100.The operation panel 160 includes a display part 161 and an operation part 163. The display part 161 is a Liquid Crystal Display (LCD) device, for example, and displays an instruction menu for a user, information about acquired image data, etc. As long as displaying images, an organic EL display may be used instead of an LCD, for example.

The operation part 163 includes a touch screen 165 and a hard key part 167. The touch screen 165 is a capacitance type. The touch screen 165 is not limited to the capacitance type, and another type such as a resistive film type, a surface acoustic wave type, an infrared type and an electromagnetic induction type can be used. The hard key part 167 includes a plurality of hard keys. The hard keys are contact switches, for example.

The external storage device 119 is controlled by the CPU 111 and is mounted with the CD-ROM 112. In the present embodiment, the CPU 111 executes a program stored in the ROM 113, by way of example. The CPU 111 may control the external storage device 119 to read a program to be executed by the CPU 111 from the CD-ROM 112 and store the read program in the RAM 114 for execution.

A recording medium for storing a program to be executed by the CPU 111 is not limited to the CD-ROM 112 but may be a medium such as a flexible disc, a cassette tape, an optical disc or a semiconductor memory. The optical disc includes Magnetic Optical Disc (MO)/MiniDisc(MD)/Digital Versatile Disc(DVD). The semi-conductor memory includes an IC card, an optical card, a mask ROM or an Erasable Programmable ROM (EPROM).

Further, the CPU 111 may load a program stored in the HDD 115 into the RAM 114 for execution in the CPU 111. The program stored in the HDD 115 includes a program downloaded by the CPU 111 from a computer connected to the Internet, or a program written in the HDD 115 by a computer connected to the Internet. The program referred to here includes not only a program directly executable by the CPU 111 but also a source program, a compressed program, an encrypted program and the like.

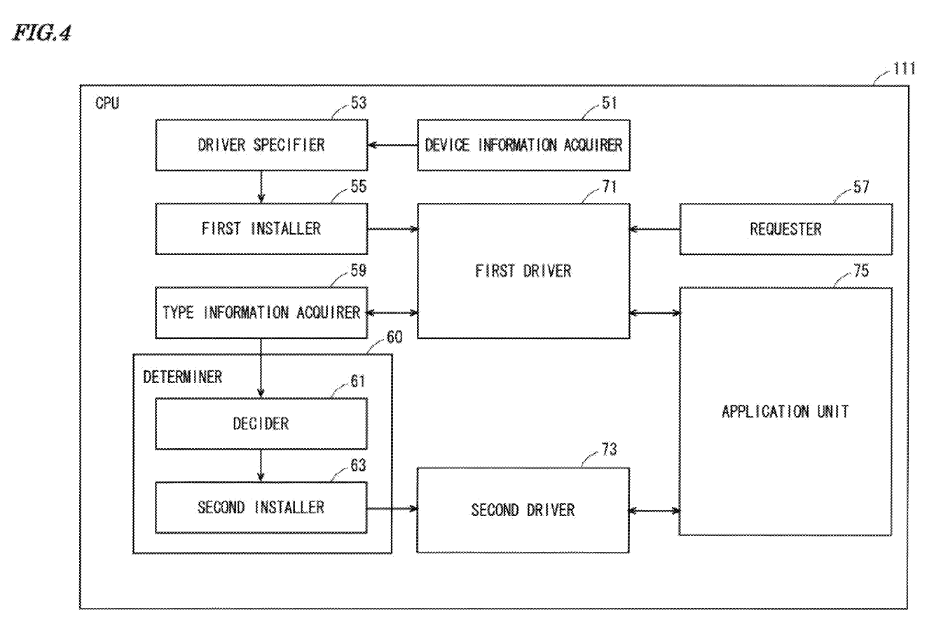

FIG. 4 is a block diagram illustrating one example of the functions of the MFP in the present embodiment. The functions illustrated in FIG. 4 are implemented by the CPU 111 included in the MFP 100 when the CPU 111 executes a driver installation program stored in the ROM 113, the HDD 115 or the CD-ROM 112. Further, these functions may be implemented by hardware.

With reference to FIG. 4, the CPU 111 included in the MFP 100 includes a device information acquirer 51, a driver specifier 53, a first installer 55, a requester 57, a type information acquirer 59, a determiner 60 and an application unit 75.

The application unit 75 is a task for execution, by the CPU 111, of a program installed in the CPU 111 in advance. Although not limited in particular, here, the application unit 75 is a task for executing an authentication process, by way of example. The authentication process is a process of deciding whether authentication information is true when the authentication information is input. Authentication information is predetermined in the MFP 100. For example, authentication information is defined for each of a plurality of users. Here, authentication information is stored in an IC card, by way of example. A user uses an IC card carried by the user and causes the card reading device 200 to read authentication information stored in the IC card. The application unit 75 authenticates the user if the authentication information received from the card reading device 200 is stored in the HDD 115, and does not authenticate the user if the authenticating information is not stored in the HDD 115. The authentication process executed by the application unit 75 does not have to be executed in the MFP 100 and may be executed in another device.

In this case, the application unit 75 executes a process of mediating the communication between the card reading device 200 and another device. The other device is the server 300, for example.

Further, authentication information may be a user ID and a password, for example. In a case in which the user operates the operation panel 160 and inputs a user ID and a password to the operation part 163, the application unit 75 authenticates the user if the input user ID and the input password are stored in the HDD 115. The application unit 75 does not authenticate the user if the input user ID and the input password are not stored in the HDD 115.

The device information acquirer 51 controls the USB controller 118. When the USB device is connected to the USB port, the USB controller 118 outputs a vendor ID and a product ID of the USB device to the CPU 111. The device information acquirer 51 acquires the vendor ID and the product ID of the USB device output by the USB controller 118. The device information acquirer 51 specifies the USB device based on the vendor ID and the product ID of the USB device, and outputs a device ID for identifying the specified USB device to the driver specifier 53 as device information of the USB device. The device information acquirer 51 acquires the device information of the USB device using a device table.

FIG. 5 is a diagram illustrating one example of a device table. With reference to FIG. 4, the device table includes a device record for each USB device. A device record associates a vendor ID and a program ID with a USB device. A device record includes an item for a device ID, an item for a device name, an item for a vendor ID and an item for a product ID. In the item for a device ID, the device identification information for identifying a USB device is set. In the item for a device name, the name of a USB device is set. In the item for a vendor ID, the information for identifying a vendor that supplies a USB device is set. In the item for a product ID, the information assigned to the type of a USB device is set.

With reference back to FIG. 4, the driver specifier 53 specifies one or more driver programs for controlling the card reading device 200. The driver specifier 53 specifies one or more driver programs by using a vendor ID and a product ID of the card reading device 200 received from the device information acquirer 51.

A plurality of driver programs respectively compatible with a plurality of devices are prepared in advance. Some card reading devices are compatible with a plurality of types of IC cards. In this case, there may be a plurality of driver programs for controlling one card reading device. Each of the plurality of driver programs is compatible with the type of an IC card. Therefore, the driver specifier 53 may specify a plurality of driver programs based on a vendor ID and a product ID of the card reading device 200.

In the present embodiment, a plurality of driver programs are stored in the server 300. The plurality of driver programs may be stored in the HDD 115. Further, the plurality of driver programs may be stored in the CD-ROM 112.

The driver specifier 53 specifies one or more driver programs using driver association information. The driver specifier 53 outputs one or more specified driver programs to the first installer 55. Driver association information associates one or more driver programs with a card reading device. In a case in which a plurality of driver programs are associated with a card reading device, the types of IC cards that are compatible with the plurality of driver programs are different from one another. Driver association information associates a plurality of driver programs with at least one of a plurality of types of card reading devices.

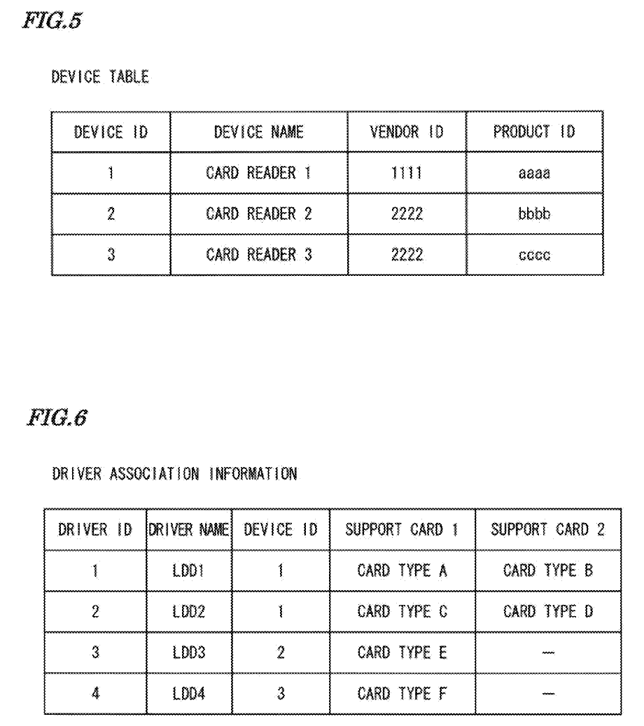

FIG. 6 is a diagram illustrating one example of driver association information. With reference to FIG. 6, driver association information includes a driver record for each driver program. A driver record that associates a USB device and a support card with a driver program includes an item for a driver ID, an item for a driver name, an item for a device ID, an item for a support card 1 and an item for a support card 2. In the item for a driver ID, driver identification information for identifying a driver program is set. In the item for a driver name, a name provided to a driver program is set. In the item for a device ID, device identification information of a USB device is set. In each of the item for a support card 1 and the item for a support card 2, a type of an IC card compatible with a driver program is set. In a case in which the number of types of cards with which a driver program is compatible is one, the type is set in the item for a support card 1, and no setting is made in the item for a support card 2. Further, in a case in which the number of types of IC cards compatible with a driver program is equal to or larger than three, the items for a support card 3 and subsequent support cards are added.

Here, it is illustrated that the driver program the driver ID of which is “1” and the driver program the driver ID of which is “2” are present for the USB device specified by the device ID “1.” Further, it is illustrated that the driver program the driver ID of which is “1” is compatible with the IC card the type of which is “CARD TYPE A” and the ID card the type of which is “CARD TYPE B.” It is illustrated that the driver program the driver ID of which is “2” is compatible with the ID card the type of which is “CARD TYPE C” and the ID card the type of which is “CARD TYPE D.”

With reference back to FIG. 4, the first installer 55 installs one of one or more driver programs specified by the driver specifier 53 as a test program. When the first installer 55 installs a driver program, a first driver 71 is formed in the CPU 111. The first driver 71 is a task for execution, by the CPU 111, of the driver program installed by the first installer 55.

In a case in which one driver program is specified by the driver specifier 53, the first installer 55 downloads the driver program from the server 300 to install the driver program, as a test program.

In a case in which a plurality of driver programs are specified by the driver specifier 53, the first installer 55 selects one of the plurality of driver programs as a test program. The first installer 55 downloads the selected test program from the server 300 to install the test program. The first installer 55 selects one of the plurality of driver programs as a test program. The first installer 55 selects a driver program having a function of determining the type of an IC card as a test program.

In a case in which there are a plurality of driver programs having a function of determining the type of an IC card, the first installer 55 selects any one of a plurality of driver programs having a function of determining the type of an IC card as a test program. In a case in which there is no driver program having a function of determining the type of an IC card, the first installer 55 selects one driver program that is compatible with the largest number of types of IC cards as a test program. In a case in which there are driver programs that are compatible with the same number of types of IC cards, the first installer 55 selects any one driver program as a test program.

In the following description, the card reading device 200 is connected to the USB controller 118 as a USB device, by way of example. Further, the vendor ID of the card reading device 200 is “1111,” and the product ID is “aaaa.” In this case, in a case in which the vendor ID “1111” and the product ID “aaaa” are input, the driver specifier 53 specifies the device ID “1” of the card reading device 200 as the device ID of the connected USB device, and outputs the device ID “1” to the driver specifier 53. In a case in which receiving the device ID “1” from the device information acquirer 51, the driver specifier 53 specifies the driver program with the driver ID “1” and the driver program with the driver ID “2” as compatible driver programs. Suppose that the driver program with the driver ID “1” has a function of determining the type of an IC card, and the driver program with the driver ID “2” does not have a function of determining the type of an IC card. In this case, the driver program with the driver ID “1” is installed as a test program by the first installer 55.

When the first driver 71 is formed in the CPU 111, the requester 57 requests the user to perform an operation of causing the card reading device 200 to read an IC card. For example, the requester 57 displays a reading operation request screen on the display part 161.

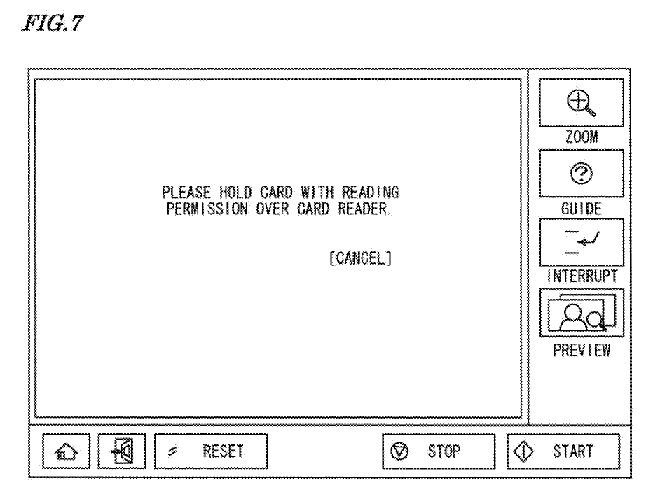

FIG. 7 is a diagram illustrating one example of a reading operation request screen. With reference to FIG. 1, the reading operation request screen includes a message “PLEASE HOLD CARD WITH READING PERMISSION OVER CARD READER.” Therefore, it is possible to request the user to perform the operation of causing the card reading device 200 to read an IC card to be used.

With reference back to FIG. 4, after the requester 57 requests the user to perform the operation of causing the card reading device 200 to read the IC card, the type information acquirer 59 outputs a card type acquiring instruction to the first driver 71. In response to receiving a card type acquiring instruction, the first driver 71 controls the USB controller 118 and causes the card reading device 200 to execute a process of determining the type of the IC card. For example, the first driver 71 causes the card reading device 200 to sequentially select a plurality of communication protocols, and causes the card reading device 200 to communicate with an IC card using a selected communication protocol. The first driver 71 may also cause the card reading device 200 to acquire the card type from the IC card. The first driver 71 may also cause the card reading device 200 to sequentially transmit signals conforming to a plurality of card standards, and identify the card type based on a response pattern provided from the IC card.

The first driver 71 outputs the type of the IC card acquired from the card reading device 200 to the type information acquirer 59 as card information. The type information acquirer 59 outputs the card information to the determiner 60.

The determiner 60 determines an adapted program that is adapted to the IC card based on the card information. The determiner 60 includes a decider 61 and a second installer 63.

The decider 61 decides whether a test program is adapted to the IC card based on the card information. With reference to the driver association information, the decider 61 decides whether the test program is adapted to the IC card. Specifically, the decider 61 decides whether the card information is set in either the item for the support card 1 or the item for the support card 2 of the driver record of the test program. If the card information is set in either the item for the support card 1 or the item for the support card 2, the decider 61 decides that the test program is adapted to the IC card. In a case in which the card information is not set in either the item for the support card 1 or the item for the support card 2, the decider 61 decides that the test program is not adapted to the IC card. In a case in which the decider 61 decides that the test program is adapted to the IC card, the determiner 60 determines that the test program is an adapted program that is adapted to the IC card.

In a case in which deciding that the test program is not adapted to the IC card, the decider 61 outputs an installation instruction to the second installer 63. The second installer 63 determines an adapted program with reference to the driver association information. The second installer 63 determines a driver program associated with card information received from the type information acquirer 59 as an adapted program based on the driver association information.

Here, the card information represents “CARD TYPE C,” by way of example. The second installer 63 determines a conforming program with reference to the driver association information. An adapted program is a driver program that is compatible with the card reading device 200 and corresponds to the card information. The adapted program is specified by a driver record in which the device ID “1” of the card reading device 200 is set in the item for the device ID and the card information “CARD TYPE C” is set in the item for the support card 1 or the item for the support card 2. In case of the present example, the driver program with the driver ID “2” is determined as an adapted program.

The second installer 63 installs the adapted program. The second installer 63 downloads the adapted program from the server 300 and installs the adapted program. When the second installer 63 installs the adapted program, a second driver 73 is formed in the CPU 111. The second driver 73 is a task for execution, by the CPU 111, of the adapted program installed by the second installer 63. Further, when installing the adapted program, the second installer 63 overwrites an execution file of the first driver 71 with an execution file of the second driver 73. When installing the adapted program, the second installer 63 may also uninstall the test program installed by the first installer 55.

In a case in which the test program is determined as an adapted program, the application unit 75 executes the authentication process using the information of the IC card received from the card reading device 200 through the first driver 71. In a case in which not a test program but another driver program is determined as an adapted program, the application unit 75 executes the authentication process using the information of the IC card received from the card reading device 200 through the second driver 73.

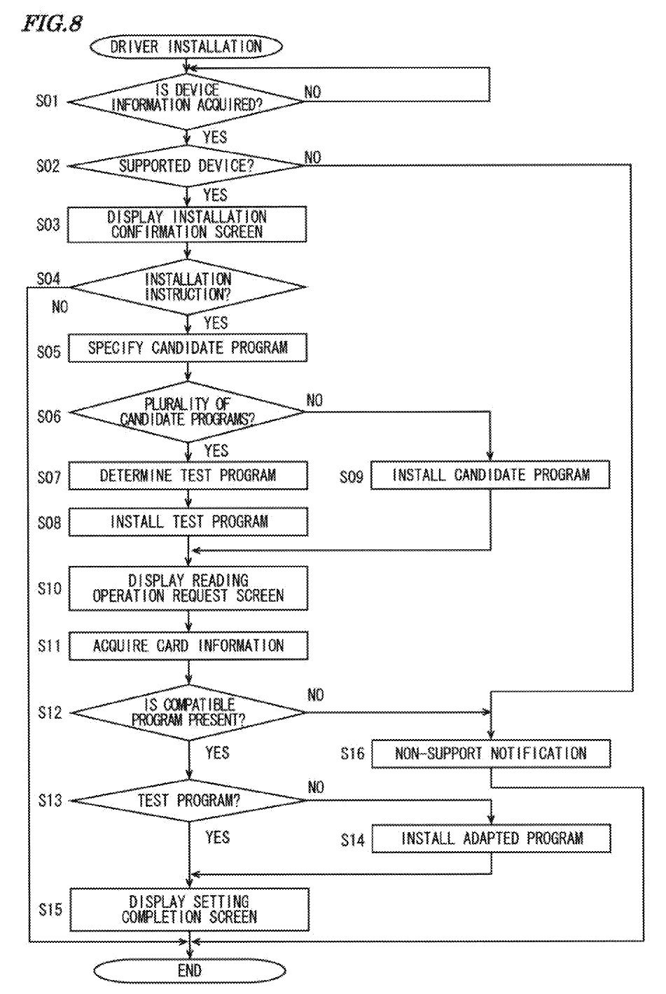

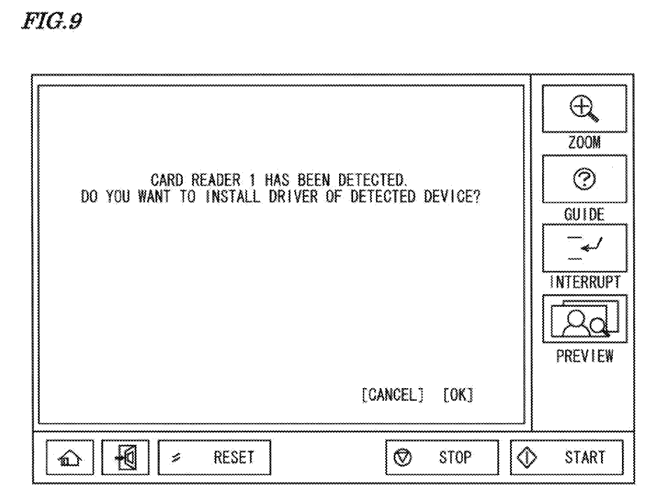

FIG. 8 is a flowchart illustrating one example of a flow of a driver installation process. The driver installation process is executed by the CPU 111 included in the MFP 100 when the CPU 111 executes a driver installation program stored in the ROM 113, the HDD 115 or the CD-ROM 112. With reference to FIG. 8, the CPU 111 included in the MFP 100 decides whether device information has been acquired (step S01). The process waits until device information is acquired (NO in the step S01). If device information is acquired (YES in the step S01), the process proceeds to the step S02.

The CPU 111 acquires device information received from the USB controller 118. When the card reading device 200 is connected to the USB port, the USB controller 118 acquires a vendor ID and a product ID from the card reading device 200. The CPU 111 acquires the vendor ID and the product ID output by the USB controller 118 as device information.

In the step S02, whether the card reading device 200 is a supported device is decided. A supported device has a driver program compatible with the supported device. In the present embodiment, a plurality of driver programs are stored in the server 300. Further, the device table one example of which is illustrated in FIG. 5 and the driver association information one example of which is illustrated in FIG. 6 are stored in the server 300. The CPU 111 downloads the device table and the driver association information in advance from the server 300 and stores the device table and the driver association information in the HDD 115. With reference to the device table, the CPU 111 decides whether the card reading device 200 connected to the USB controller 118 is a supported device. If a device record including the device information is present in the device table, the CPU 111 decides that the card reading device 200 is a supported device. If a device record including the device information is not present in the device table, the CPU 111 decides that the card reading device 200 is not a supported device.

In a case in which it is decided that the card reading device 200 is a supported device, the process proceeds to the step S3. If not, the process proceeds to the step S16. In the step S16, a notification indicating that the card reading device 200 is not supported is provided, and the process ends. The CPU 111 displays, on the display part 161, a message indicating that the card reading device 200 is not a supported device or a message indicating that a driver program compatible with the card reading device 200 is not present.

In the step S03, an installation confirmation screen is displayed, and the process proceeds to the step S04. The installation confirmation screen is a screen for confirming with the user whether to install a driver program of the card reading device 200.

FIG. 9 is a diagram illustrating one example of an installation confirmation screen. With reference to FIG. 9, the installation confirmation screen includes a message “CARD READER 1 HAS BEEN DETECTED. DO YOU WANT TO INSTALL DRIVER OF DETECTED DEVICE?” Further, the installation confirmation screen includes a button on which the character string “CANCEL” is displayed and a button on which the character string “OK” is displayed. In a case in which the button on which the character string “OK” is displayed is designated by the user, the CPU 111 accepts an installation instruction provided by the user. In a case in which the button on which the character string “CANCEL” is displayed is designated by the user, the CPU 111 accepts a non-installation instruction provided by the user.

With reference back to FIG. 8, in the step S04, whether an installation instruction has been accepted is decided. If an installment instruction has been accepted, the process proceeds to the step S05. If not, the process ends. In the step S05, a candidate program is specified. The CPU 111 specifies one or more driver programs using the device information acquired in the step S01.The device information includes a vendor ID and a product ID. With reference to the device table stored in the HDD 115, the CPU 111 specifies a device ID associated with the device information. Next, with reference to the driver association information stored in the HDD 115, the CPU 111 extracts all driver records including the device ID. The CPU 111 determines driver programs specified by all of the one or more extracted driver records as candidate programs.

In the step S06, whether there are a plurality of candidate programs is decided. If there are a plurality of candidate programs, the CPU 111 causes the process to proceed to the step S07. If not, the CPU 111 causes the process to proceed to the step S09. In the step S09, a candidate program is installed, and the process proceeds to the step S10. The CPU 111 downloads the candidate program from the server 300 and installs the downloaded candidate program.

In the step S07, a test program is determined, and the process proceeds to the step S08. In a case in which the process proceeds to the step S07, a plurality of candidate programs are determined. In the step S08, one of the plurality of candidate programs is determined as a test program. The CPU 111 determines a candidate program having a function of deciding the type of an IC card as a test program. In a case in which there are a plurality of candidate programs having the function of deciding the type of an IC card, the CPU 111 determines any one of the plurality of candidate programs having the function of determining the type of an IC card as a test program.

In the step S08, the test program is installed, and the process proceeds to the step S09. The CPU 111 downloads the test program from the server 300 and installs the downloaded test program. In the step S10, the reading operation request screen is displayed, and the process proceeds to the step S11. The CPU 111 displays the reading operation request screen illustrated in FIG. 7 on the display part 161. The reading operation request screen includes a message for requesting the user to perform an operation of causing the card reading device 200 to read an IC card to be used. Therefore, the user who views the reading operation request screen can perform the work for causing the card reading device 200 to read the IC card at an appropriate point in time.

In the step S11, card information is acquired, and the process proceeds to the step S12. The CPU 111 instructs a task for execution of a test program to acquire the type of the IC card. The task for execution of a test program controls the USB controller 118 and causes the card reading device 200 to execute a process of determining the type of the IC card. When the user performs the work for causing the card reading device 200 to read the IC card, the card reading device 200 acquires the type of the IC card as card information and outputs the card information to the USB controller 118. The CPU 111 acquires the card information which the USB controller 118 receives from the card reading device 200.

In the step S12, whether an adapted program is present is decided. If an adapted program is present, the process proceeds to the step S13. If not, the process proceeds to the step S14. The CPU 111 determines an adapted program that is adapted to the IC card based on the card information.

With reference to the driver association information stored in the HDD 115, the CPU 111 determines an adapted program that is adapted to the IC card. A driver program that is associated with the device information acquired in the step S01 and the card information acquired in the step S11 by the driver association information is determined as an adapted program. If an adapted program associated with the device information and the card information is present, the process proceeds to the step S13. If not, the process proceeds to the step S16.

In the step S16, a notification indicating that an adapted program is not present is provided, and the process ends. The CPU 111 displays, on the display part 161, a message indicating that the card reading device 200 is not a supported device or a message indicating that a driver program compatible with the card reading device 200 is not present.

In the step S13, whether an adapted program is same as the test program is decided. If the adapted program is same as the test program, the process proceeds to the step S15. If not, the process proceeds to the step S14.In a case in which the process proceeds to the step S15, because the test program is determined as an adapted program, it is not necessary to install an adapted program separately.

An adapted program is installed in the step S14, and the process proceeds to the step S15. The CPU 111 downloads an adapted program from the server 300 and installs the downloaded adapted program. At this time, an execution file of the test program is overwritten with an execution file of the adapted program. When the adapted program is installed, the test program may be uninstalled.

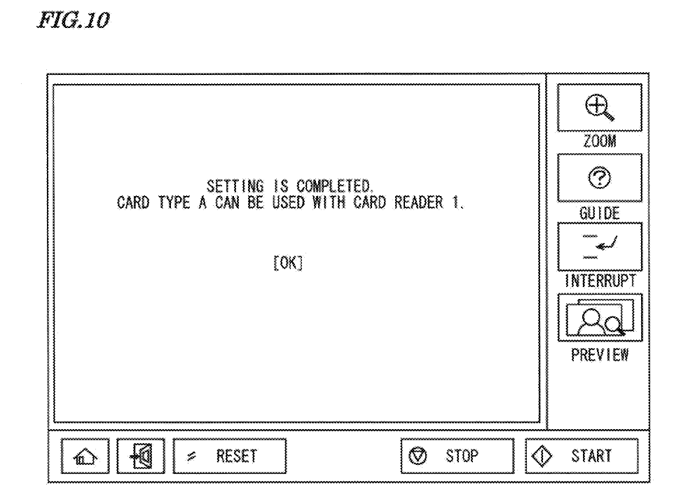

In the step S15, a setting completion screen is displayed, and the process ends. FIG. 10 is a diagram illustrating one example of a setting completion screen. With reference to FIG. 10, the setting completion screen includes a message “SETTING IS COMPLETED. CARD TYPE A CAN BE USED WITH CARD READER 1.” Therefore, it is possible to notify the user that the setting for reading an IC card using the card reading device 200 is completed.

### Modified Example

In the step S07 of the driver installation process illustrated in FIG. 8, in a case in which a candidate program having a function of determining the type of an IC card is not present, the CPU 111 may select one program that is compatible with the largest number of types of IC cards as a test program. Further, in a case in which there are programs that are compatible with the same number of types of IC cards, the CPU 111 may select any one program as a test program. In this case, in a case in which a test program is not adapted to an IC card, a candidate program different from the test program is determined as a new test program, and the process of the steps S09 to the step S12 is executed.

In the above-mentioned embodiment, the MFP 100 is described as one example of an image processing apparatus. An image processing apparatus is only required to have a function of processing images. For example, an image processing apparatus may be a printer that forms an image, a scanner device that reads a document, or a facsimile machine that transmits and receives facsimile data.

As described above, the MFP 100 in the present embodiment functions as an image processing apparatus. The MFP 100 includes the USB controller 118 to which the card reading device 200 is connected, and the CPU 111. The CPU 111 acquires device information representing the type of the card reading device 200 connected to the USB controller 118, and installs one test program out of a plurality of candidate programs corresponding to the device information. At this stage, the CPU 111 can control the card reading device 200 by using a driver which is a task for executing a test program.

Then, the CPU111 controls a driver, which is a task for executing the test program, to acquire card information indicating the type of the IC card to be read by the card reading device 200. Based on the card information, the CPU 111 determines an adapted program that is adapted to the IC card from among the plurality of candidate programs. Even in a case in which a test program is not adapted to the IC card, a driver program adapted to the IC card can be specified. Therefore, a user is not required to input information about the card reading device 200 and the type of the IC card. Therefore, the user is only required to perform an operation of causing the card reading device 200 to read an IC card to be used. Therefore, it is possible to facilitate a user setting operation for causing the card reading device 200 connected to the MFP 100 to be controllable.

Further, the CPU 111 decides whether the test program is adapted to the IC card based on the card information. In a case in which it is decided that the test program is not adapted to the IC card, the CPU 111 installs an adapted program instead of the test program. Therefore, because the adapted program that is adapted to the IC card is automatically installed, a user operation can be simplified.

Further, the CPU 111 decides, for each of a plurality of types of card reading devices, whether a test program is compatible with an IC card using driver association information that associates one or more card information pieces with a plurality of driver programs compatible with the card reading device. Therefore, it is easy to decide whether the test program is compatible with the IC card.

Further, the CPU 111 specifies the plurality of driver programs corresponding to device information as a candidate program using the driver association information. Therefore, the plurality of driver programs for controlling the card reading device 200 can be easily specified based on the device information.

Further, because card information is acquired, the CPU 111 displays, on the display part 161, a reading operation request screen for requesting the user to perform an operation of causing the card reading device 200 to read an IC card. Therefore, the card reading device 200 can reliably acquire the card information. Further, it is possible to synchronize a process executed by the MFP 100 with a user operation, and acquire the card information.

### Overview of Embodiment

(Item 1) An image processing apparatus includes a hardware processor equipped with an interface to which a card reading device is connected, wherein the hardware processor acquires device information representing a type of the card reading device connected to the interface, installs any one test program out of a plurality of driver programs corresponding to the device information, controls a driver that executes the test program to acquire card information representing a type of a card to be read by the card reading device, and determines, based on the card information, an adapted program that is adapted to the card from among the plurality of driver programs.

According to this aspect, the device information of the card reading device connected to the interface section is acquired, and any one of the plurality of driver programs corresponding to the device information is installed as a test program. At this stage, it is possible to control the card reading device using a driver that executes the test program. Then, the card information of a card to be read by the card reading device is acquired by control of the driver that executes the test program, and an adapted program that is adapted to the card is determined based on the card information. Even in a case in which the test program is not adapted to the card, the driver program adapted to the card can be specified. Therefore, the user is not required to input information about the card reading device and the type of the card. As a result, it is possible to provide the image processing apparatus that facilitates a user setting operation for enabling control of the card reading device.

(Item 2) The image processing apparatus according to item 1, wherein the hardware processor further decides, based on the card information, whether the test program is adapted to the card, and in a case in which it is determined that the test program is not compatible with the card, installs the compatible program instead of the test program.

According to this aspect, in a case in which the test program is not adapted to the card, the adapted program is installed instead of the test program. Therefore, the adapted program that is adapted to the card is automatically installed, so that a user operation can be simplified.

(Item 3) The image processing apparatus according to item 2, wherein the hardware processor decides whether the test program is compatible with the card based on driver association information, with the driver association information associating, in regard to each of a plurality of types of the card reading devices, each of the plurality of driver programs compatible with the card reading device with one or more card information pieces.

According to this aspect, in regard to each of the plurality of types of card reading devices, the driver association information associates the one or more respective card information pieces with the plurality of respective driver programs compatible with the card reading device. Therefore, it is easy to decide whether the test program is compatible with the card.

(Item 4) The image processing apparatus according to any one of items 1 to 3, wherein the hardware processor further specifies the plurality of driver programs corresponding to the device information based on driver association information, with the driver association information associating at least one of a plurality of types of the card reading devices with the plurality of driver programs.

According to this aspect, the driver association information associates the plurality of driver programs with at least one of the plurality of types of card reading devices. Therefore, the plurality of driver programs for controlling the card reading device can be easily specified based on the device information.

(Item 5) The image processing apparatus according to any one of items 1 to 4, wherein the hardware processor further requests, before the card information is acquired, a user operation of causing the card reading device to read the card.

According to this aspect, the user is required to perform an operation of causing the card reading device to read the card before the card information is acquired. Therefore, the card information can be reliably acquired by the card reading device. Further, it is possible to synchronize a process executed by the image processing apparatus with a user operation, and acquire the card information.

(Item 6) A driver installation method is executed by an image processing apparatus, with the image processing apparatus being equipped with an interface to which a card reading device is connected, and includes acquiring device

information representing a type of the card reading device connected to the interface, installing any one test program out of a plurality of driver programs corresponding to the device information, controlling a driver that executes the test program and acquiring card information representing a type of a card to be read by the card reading device, and determining, based on the card information, an adapted program that is adapted to the card from among the plurality of driver programs.

According to this aspect, it is possible to provide the driver installation method that facilitates a user setting operation for enabling control of the card reading device.

(Item 7) A computer-readable recording medium is encoded with a driver installation program, with the driver installation program being executed by a computer that controls an image processing apparatus equipped with an interface to which a card reading device is connected, wherein the driver installation program causes the computer to acquire device information representing a type of the card reading device connected to the interface section, install any one test program out of a plurality of driver programs corresponding to the device information, control a driver that executes the test program and acquire card information representing a type of a card to be read by the card reading device, and determine, based on the card information, an adapted program that is adapted to the card from among the plurality of driver programs.

According to this aspect, it is possible to provide the driver installation program that facilitates a user setting operation for enabling control of the card reading device.

Although embodiments of the present invention have been described and illustrated in detail, the disclosed embodiments are made for purpose of illustration and example only and not limitation. The scope of the present invention should be interpreted by terms of the appended claims.

What is claimed is:

1. An image processing apparatus comprising a hardware processor equipped with an interface to which a card reading device is connected, wherein
the hardware processor
acquires device information representing a type of the card reading device connected to the interface,
installs any one test program out of a plurality of driver programs corresponding to the device information,
controls a driver that executes the test program to acquire card information representing a type of a card to be read by the card reading device, and determines, based on the card information, an adapted program that is adapted to the card from among the plurality of driver programs.

2. The image processing apparatus according to claim 1, wherein
the hardware processor further
decides, based on the card information, whether the test program is adapted to the card, and
in a case in which it is determined that the test program is not compatible with the card, installs the compatible program instead of the test program.

3. The image processing apparatus according to claim 2, wherein
the hardware processor decides whether the test program is compatible with the card based on driver association information, with the driver association information associating, in regard to each of a plurality of types of the card reading devices, each of the plurality of driver programs compatible with the card reading device with one or more card information pieces.

4. The image processing apparatus according to claim 1, wherein
the hardware processor further specifies the plurality of driver programs corresponding to the device information based on driver association information, with the driver association information associating at least one of a plurality of types of the card reading devices with the plurality of driver programs.

5. The image processing apparatus according to claim 1, wherein
the hardware processor further requests, before the card information is acquired, a user operation of causing the card reading device to read the card.

6. A driver installation method that is executed by an image processing apparatus, the image processing apparatus being equipped with an interface to which a card reading device is connected, including:
acquiring device information representing a type of the card reading device connected to the interface;
installing any one test program out of a plurality of driver programs corresponding to the device information;
controlling a driver that executes the test program and acquiring card information representing a type of a card to be read by the card reading device; and
determining, based on the card information, an adapted program that is adapted to the card from among the plurality of driver programs.

7. The driver installation method according to claim 6, further including:
deciding, based on the card information, whether the test program is adapted to the card; and
in a case in which it is decided that the test program is not adapted to the card, installing the adapted program instead of the test program.

8. The driver installation method according to claim 7, further including deciding whether the test program is compatible with the card based on driver association information, with the driver association information associating, in regard to each of a plurality of types of the card reading devices, each of the plurality of driver programs compatible with the card reading device with one or more card information pieces.

9. The driver installation method according to claim 6, further including specifying the plurality of driver programs corresponding to the device information based on driver association information, with the driver association information associating at least one of a plurality of types of the card reading devices with the plurality of driver programs.

10. The driver installation method according to claim 6, further including requesting, before the card information is acquired, a user to perform an operation of causing the card reading device to read the card.

11. A computer-readable recording medium encoded with a driver installation program, the driver installation program being executed by a computer that controls an image processing apparatus equipped with an interface to which a card reading device is connected, wherein
the driver installation program causes the computer to
acquire device information representing a type of the card reading device connected to the interface,
install any one test program out of a plurality of driver programs corresponding to the device information,
control a driver that executes the test program and acquire card information representing a type of a card to be read by the card reading device, and
determine, based on the card information, an adapted program that is adapted to the card from among the plurality of driver programs.
